(19) United States
(12) Patent Application Publication
(10) Pub. No.: US 2014/0232679 A1
(43) Pub. Date: Aug. 21, 2014

(54) SYSTEMS AND METHODS TO PROTECT AGAINST INADVERTANT ACTUATION OF VIRTUAL BUTTONS ON TOUCH SURFACES

(71) Applicant: MICROSOFT CORPORATION, Redmond, WA (US)

(72) Inventors: Christopher Whitman, Fort Collins, CO (US); Scott Fudally, Duvall, WA (US); Paul Millsap, Seattle, WA (US); Naresh Molleti, Redmond, WA (US); Carl Picciotto, Clyde Hill, WA (US); Scott Mail, Seattle, WA (US); Dan Johnson, Milliken, CO (US)

(73) Assignee: Microsoft Corporation, Redmond, WA (US)

(21) Appl. No.: 13/782,137

(22) Filed: Mar. 1, 2013

Related U.S. Application Data
(63) Continuation-in-part of application No. 13/769,356, filed on Feb. 17, 2013.

(51) Int. Cl. G06F 3/041

(52) U.S. Cl. CPC G06F 3/041
USPC 345/174; 345/173

(57) ABSTRACT

Systems and methods of defending and/or guarding against inadvertent actuation of a virtual button upon a touch sensitive screen and/or device. A virtual button may be a touch sensor, set of touch sensors and/or touch areas upon a touch screen—the actuation of which may be associated with the execution of a process. In one embodiment, a virtual button may comprise a first touch area and a second guarding area. Certain touches and other conditions within the first touch area and/or second guarding area may be interpreted by the device as either intentional or inadvertent. If the touches are interpreted as inadvertent, then the process associated with the virtual button may be suppressed.

### CROSS-REFERENCE TO RELATED APPLICATION

This application is a continuation-in-part application of, and takes benefit of priority from, pending U.S. application Ser. No. 13/769,356 filed 17 Feb. 2013—which is incorporated herein by reference.

### BACKGROUND

In the area of touch sensitive screens, there are many known technologies and techniques for the sensing of touch as a means to activate processing on a touch-enabled device. Such technologies include, but are not limited to: capacitive sensing, piezo pressure sensing, force sensitive resistors (FSR), piezo-resistive elements and the like.

Often, actuating “virtual buttons” (i.e., areas on touch sensitive screens that—upon a user's touch—means to affect some function, like e.g., hitting a real button) on a touch screen surface may tend to have certain challenges. For example, virtual buttons may tend to feel different from authentic mechanical buttons that have an “up” and “down” feel to their actuation. Virtual buttons may also have a high number of “false” readings—i.e., they may poorly indicate to the system (which detecting touches and interpreting their meaning) that the user has intended to push a virtual button on the screen.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

Systems and methods of defending and/or guarding against inadvertent actuation of a virtual button upon a touch sensitive screen and/or device. A virtual button may be a touch sensor, set of touch sensors and/or touch areas upon a touch screen—the actuation of which may be associated with the execution of a process. In one embodiment, a virtual button may comprise a first touch area and a second guarding area. Certain touches and other conditions within the first touch area and/or second guarding area may be interpreted by the device as either intentional or inadvertent. If the touches are interpreted as inadvertent, then the process associated with the virtual button may be suppressed.

In another embodiment, a touch screen system is disclosed, comprising: a touch screen; a controller for receiving touch signals from said touch screen; wherein said touch screen comprises at least one virtual button, said virtual button further comprising a first touch area and a second guarding area, said second guarding area disposed substantially near said first touch area; and wherein further said controller capable of receiving touch signals from said first touch area and said second guarding area and said controller capable of actuating at least one process according to the satisfaction of a set of touch conditions.

In yet another embodiment, a method is disclosed for guarding a touch screen system from actuating a process associated with touch upon a virtual button upon said touch screen when such touch is inadvertent. The method comprising: receiving a set of first touch signals from a first touch area, said first touch area within said virtual button; receiving a set of second touch signals from a second guarding area, said second guarding area substantially near said first touch area; testing conditions involving said first touch signals and said second touch signals; actuating a process associated with a touch upon said virtual button depending upon the satisfaction of said conditions.

Other features and aspects of the present system are presented below in the Detailed Description when read in connection with the drawings presented within this application.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIGS. 1A and 1B are two embodiments of piezo-actuated structures mated to a deformable layer on a touch sensitive surface, as made in accordance with the principles of the present application.

FIGS. 2A and 2B depict two other embodiments of a piezo-actuator structures that may suffice for a touch sensitive surface, as made in accordance with the principles of the present application.

FIG. 3A depicts one embodiment of a piezo structure as made in a cantilever configuration.

FIG. 3B depicts a graph of force vs. displacement of one embodiment of a piezo structure.

FIGS. 4A and 4B depict two embodiments of control lines for a structure comprising a piezo structure and capacitive sensing structure.

FIGS. 5A and 5B depict two embodiments of waveforms for signals driving piezo structures, as made in accordance with the principles of the present application.

FIG. 6 is one embodiment of piezo sensing circuit.

FIG. 7 is one embodiment of a piezo driving circuit.

FIG. 8 is one embodiment of one embodiment of a piezo controller in communication with a piezo drive circuit and piezo element.

FIG. 9A is one embodiment of a touch screen comprising a virtual button area with additional neighboring guarding sensor areas.

FIGS. 9B to 9I are exemplary embodiments of touches and/or movements that might occur within a VB area with neighboring guarding sensors.

FIG. 10 is one embodiment of a flowchart for a process that may allow a present system to process touches and/or movements that may occur within a VB area with neighboring guarding sensors.

### DETAILED DESCRIPTION

As utilized herein, terms “component,” “system,” “interface,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

### Introduction

In many embodiments of the present system, a piezo-actuated bender may be employed to provide suitable virtual button actuation. In preferred embodiments “piezo” may refer to benders employing piezoceramic materials, for example PZT, but it may also refer to benders employing other piezoelectric materials such as electroactive polymers or electromechanical polymers. The bender may be in whatever form (e.g., a bar, disk, or any other desired shape) is convenient for the application (e.g., virtual button on a touch-sensitive tablet, a virtual button or the like). In many embodiments, such piezo-actuated bender may be mechanically mated (e.g., glued, affixed by support structures or the like) to the surface of a suitably bendable touch surface—e.g., thin glass, plastic or the like—in order to simulate a “dome switch”, mechanical button or some other haptic sensation.

Such a piezo-actuated button and/or bender may be able to sense finger pressure and/or position—for, e.g., sensing an intentional button actuation by the user and/or to prevent unintentional button actuation. In other embodiments, it may be possible to employ one or more capacitive sensors (in addition to the piezo-actuated bender/button) to aid in sensing finger position, pressure and motion for decreasing the incidence of such false-positives (i.e., failing to detect an inadvertent user actuation) and false-negatives (i.e. failing to detect an intentional user actuation).

In other embodiments, apart from pressure sensing from piezo-layers and/or structures, it may be possible to incorporate other sensing devices—for example, force sensitive resistors (FSR), piezo-resistive elements, capacitive sensing and/or any other devices, means and/or methods known in the art. These pressure-sensing devices may be incorporated with the piezo structures mentioned herein—and may be used in any combination possible. In fact, one embodiment may be to sense pressure with a non-piezo based structure (even though the piezo structure may be capable of sensing pressure itself). It may suffice for the purposes of the present application that pressure-sensing capability be possible with many of the embodiments disclosed herein.

In other embodiments, it may be possible to use orientation sensors to inform the system (e.g., smart phone or tablet using such a touch screen) when button pushes may be valid or invalid. It may also be desirable to have the system allow a digital pen/pencil to disable and prevent actuation when such digital pen/pencil is in use.

Embodiments of Piezo-Actuated Structures

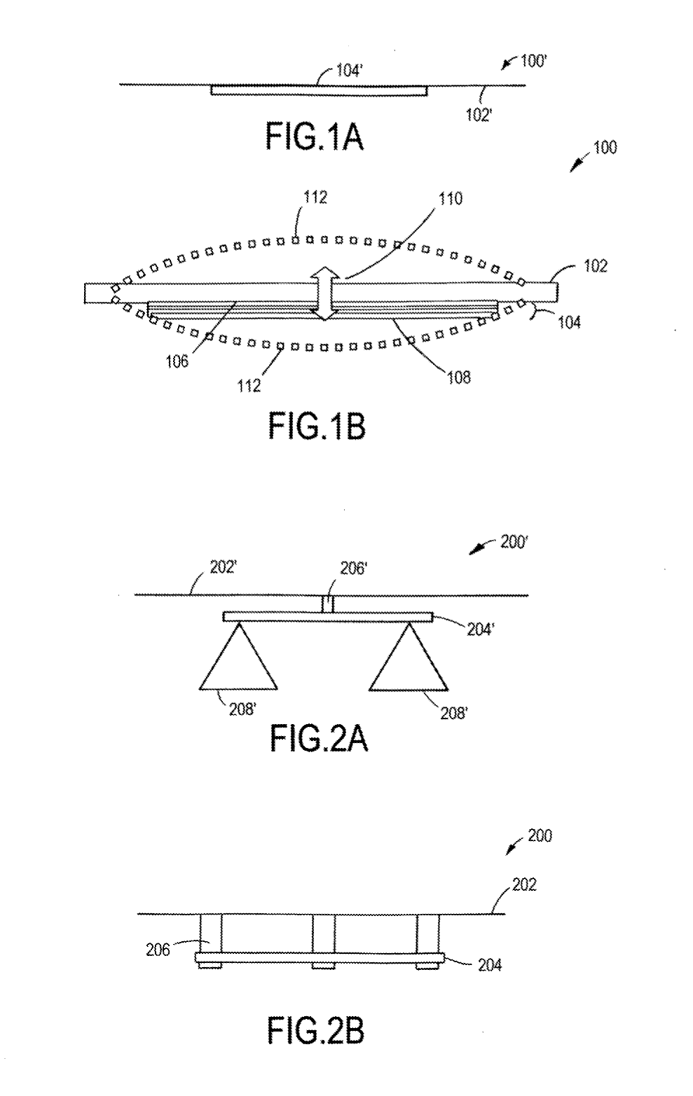

FIGS. 1A and 1B are two possible embodiments (100′ and 100, respectively) of piezo-actuated structures (104′, 104) mated to a deformable layer (102′, 102)—e.g., such as on a touch sensitive surface. As shown, piezo-actuated structures may comprise a single (104′) or multi-layered (104) structures, depending on various factors, including the manner of mechanical mating to the piezo structure to deformable layer (102′, 102). In this embodiment, it is possible to achieve a suitable mechanical mating with an adhesive layer 106. Adhesive layer 106 bonds piezo actuator 108 to deformable layer 102. Deformable layer (102′, 102) may comprise glass (e.g. “Gorilla Glass”) or some transparent/translucent plastic layer suitable for a transparent display.

In one embodiment, deformable layer (102′, 102) should be of a suitable thickness (e.g., depending upon the material used), such that an average depression (e.g., a user pressing a finger) allows a suitable deformation 112 to allow detection by a sensor and/or circuit, as will be discussed herein.

FIGS. 2A and 2B are other embodiments of suitable piezo-actuator structures (200′ and 200, respectively) that may suffice for a touch sensitive surface 200. As with FIG. 1, deformable layer (202′, 202) provides suitable deformation/deflection upon actuation by the piezo layer (204′, 204), and by a touch from a user, if pressure sensing is to be employed. Piezo layer (204′, 204) may be mechanically mated to deformable layer (202′, 202) as before, with any known mechanical mating (e.g., adhesive, gluing, chemical bonding, mechanical fixtures or the like), or simply positioned to push, particularly at its center point.

In FIG. 1A, piezo layer 204′ is also in mechanically communication to layer 202′ via a pusher structure 206′—which may also communicate pressure from touches or piezo actuation. Piezo layer 204′ is also supported by support structures 208′, as seen in FIG. 1A. Support structures may be mechanically mated to the piezo layer and/or may be in mechanical communications (e.g., touching) the piezo layer.

In FIG. 1B, there is a plurality of stood-off mounting portions 206. Mounting portions 206 may position the piezo away from the deformable layer 202 to allow the piezo to bend at an optimal radius, while pushing deformable layer 202 about the center point of piezo layer 204. Mounting portions 206 may provide a sufficient amount of electrical and/or mechanical insulation or damping from surrounding piezo and/or capacitive structures. In addition, mounting portions 206 may be constructed to provide mechanical dampening of deformations from user touches in the near vicinity—e.g., a touch meant for one area of the touch surface but which may be confused for a touch meant for a different piezo structures.

In one embodiment, it may be desirable to simulate a “virtual dome switch”. Such a switch may comprise a piezo bender (as shown in FIGS. 1 and 2), glued to (or mounted against) the underside of glass (for example, Gorilla Glass at about 0.55 mm thickness)—and which, when stimulated with an electrical pulse and/or waveform, bends the glass and transmits a sharp feeling to a person's finger, simulating the experience of an actuated dome switch. In one embodiment the pulse is produced upon both the press and release of the person's finger, thus creating complete in/out dome switch experience. In other embodiments, the pulse may be produced only upon press (or only upon release) to simulate other types of switches or under light touches to provide sensations of the surface texture to help people locate the button before actuation—e.g., when in the dark or not looking directly at the button

Embodiments for Piezo Actuation

In addition to the embodiments mentioned in FIGS. 1A, 1B and 2A and 2B above, there are several ways in which the piezo bender and/or bar may be implemented. When a voltage is applied to a piezo bar, the piezo bar tries to elongate or foreshorten. Using this effect, there are two possible implementations may be realized either as a “unimorph” configuration or, alternatively, as a “bimorph” configuration.

In a unimorph configuration, a single piezo bar may be mated (e.g. by gluing or otherwise affixing in any known manner) to a rigid backing. By contrast, in a bimorph configuration, two piezo-structures may be glued, mechanically mated and/or otherwise layered on top of each other. If two piezos are glued on top of each other, and if one piezo foreshortens while the other elongates, then the whole structure will bend.

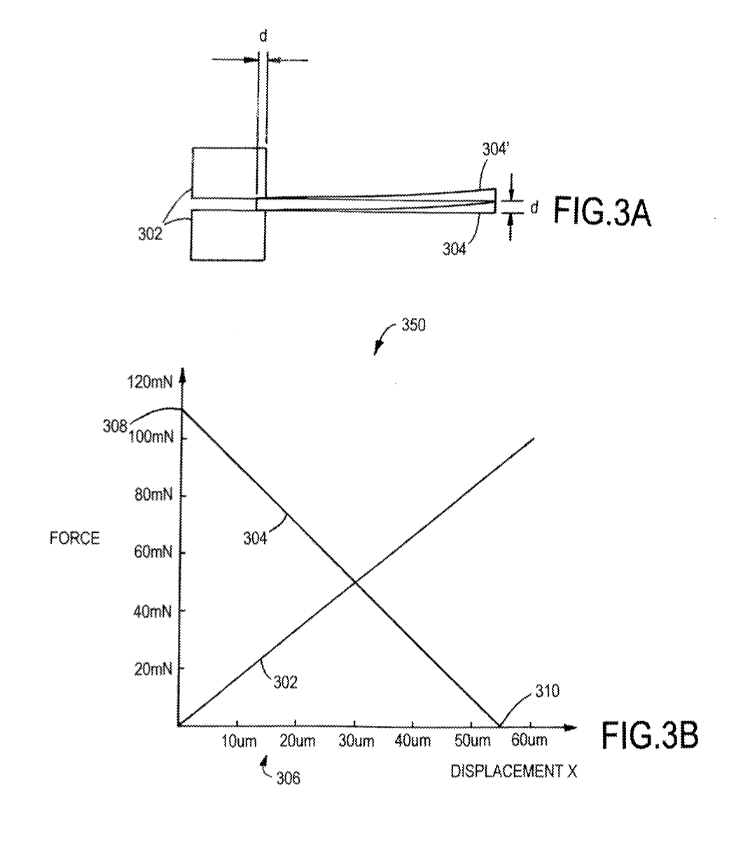

A bimorph configuration may work well in a three-point-mounting configuration (as depicted in FIG. 2A), where it may not be desirable to glue the bar along its length to a rigid structure. Alternatively, a unimorph or a bimorph configuration may work in a cantilever configuration (as depicted in FIG. 3A). In FIG. 3A, piezo structure 304 may be mated to a clapping fixture 302 (e.g., embedded to a depth of d, as shown—and as desired to affect the suitable deflection). Piezo 304 may comprise a free end that allows for a displacement (shown as 304′) when actuated.

### One Embodiment

In the embodiment whereby a piezo bar is glued along the entire length of the glass, it may be desired to allow the glass sufficient freedom of movement to bend. To affect this, it may be desired to provide for a gap depth in the adhesive securing the glass to any nearby structures, such as a bezel or frame.

With this gap depth (e.g., 20 mm), it may be possible to achieve a suitable deflection range (e.g. possibly 10-12 um deflection) for piezo bar driven at a desired voltage (e.g. 30V). At higher voltage (e.g., 60V), it may be possible to achieve a larger deflection (e.g., 18-20 um). In one embodiment, it may be desirable to achieve an effective glass stiffness of approximately 40N/mm.

As in some embodiments, a larger gap may not necessarily provide greater flexibility—while a smaller gap may reduce flexibility. A gap of zero, however, may tend to constrict the glass to very small deflections (e.g., 2-3 microns at 30V). Such different configurations are possible; but it may be desirable to implement the sensing elements to perform for these various displacements.

To better understand the operation of the piezo bar, the piezo bar may be characterized in terms of:
(1) BF (blocking force): the force exerted by the bar when constrained and not allowed to move; and
(2) FD (free displacement): the displacement of the bar when totally unopposed.

These specifications have a particular context (as depicted in FIG. 3A). However, these specifications apply in the configuration where the piezo bar is glued (or otherwise mated) to the glass along the length, and the deflection occurs in the middle (e.g., “three-point mounting”, whereby the two ends and the center point are mechanically mated). The stiffness of the piezo bar may be derived from BF/FD. With BF and FD, it may be possible to know the stiffness of the load and possible to calculate (or otherwise model) the deflection from a static standpoint (i.e. where the inertial effects of mass may be ignored and just consider balanced forces at steady state).

Haptic Response

With these configurations, it may be possible to create a haptics response for a virtual button that: (1) may be localized to the finger; (2) may be felt in any of the touch screen's orientations (e.g., in the hand, flat on the table, in the user's lap, propped up on its stand on a table, etc.); (3) may not need mechanical isolation; and (4) may function under a continuous sheet of glass. In addition, these configurations may provide varies haptic response, for example to indicate finger proximity.

For example, in the embodiment comprising a piezo bar/bender mated to the underside of the glass, it may be possible to provide and/or transmit a haptic response such as a positive, localized click feeling. In this case, the bender bends the glass, and the user may feel this sensation on the fingertip. In addition, this embodiment may not require “mechanical isolation”—i.e., the need for the construction of a mechanically distinct structure.

Proximity Sensing and Activation on Pressure

As a piezo bar may be implemented as a wideband device, it may be driven in a variety of ways to create varying haptic feelings—e.g., from buzzes to clicks. It may also be used as a pressure sensor “for free,” allowing for a different modality of virtual button interaction.

In one embodiment, it is possible to affect capacitive sensing (“capsense” or “capsensing”) to work in conjunction with the piezo structures recited herein. Capsense may function as before, may be used to detect proximity, and trigger a haptic buzz, thus, aiding the user in locating the button. Pressure sensing of the piezo structure may aid in determining actual button actuation. Haptics—working in conjunction with pressure—may give a very convincing virtual button and/or dome switch feeling.

In one embodiment, to impart a strong click feeling, it may be possible to account for peak surface velocity, as another possible control parameter, such as peak surface deflection. For example, in one embodiment, a target for peak velocity around 20-30 mm/sec may suffice for such effect.

In this embodiment, it may be desired to have a suitable deflection. FIG. 3B is a graph of force vs. displacement modeled for one embodiment. As seen, a displacement of around 10 um may be desired in order to sense actuation—with 20-30 um being a more comfortable operating point.

In the graph of FIG. 3B, the load is represented by line 302, and the BF/FD performance of the piezo is represented by line 304. The resultant deflection is given by where the lines cross, where the force balances.

In this example, at a BF of 0.6N, a FD of 60-microns, and a glass load of 40N/mm, the deflection is approximately 12 um. Of course, a different piezo bar may be designed to meet a desired deflection. For example, a bar with greater BF and smaller FD might cross the line at the same point. Thus, some designing may go into matching a piezo bar to a load of known stiffness and mass, while optimizing deflections and velocities.

In some embodiments, it may be desirable to have a piezo bar that leans towards greater BF, to accommodate greater stiffness in the glass, if needed, to provide a little margin. In addition, BF and FD may be affected by changing piezo geometries. In FIG. 3B, for a particular piezo device, 308 shows the BF (the force at zero displacement 306), and 310 shows the free displacement, the unopposed static displacement.

Embodiments Using Capsense with Piezo Structures

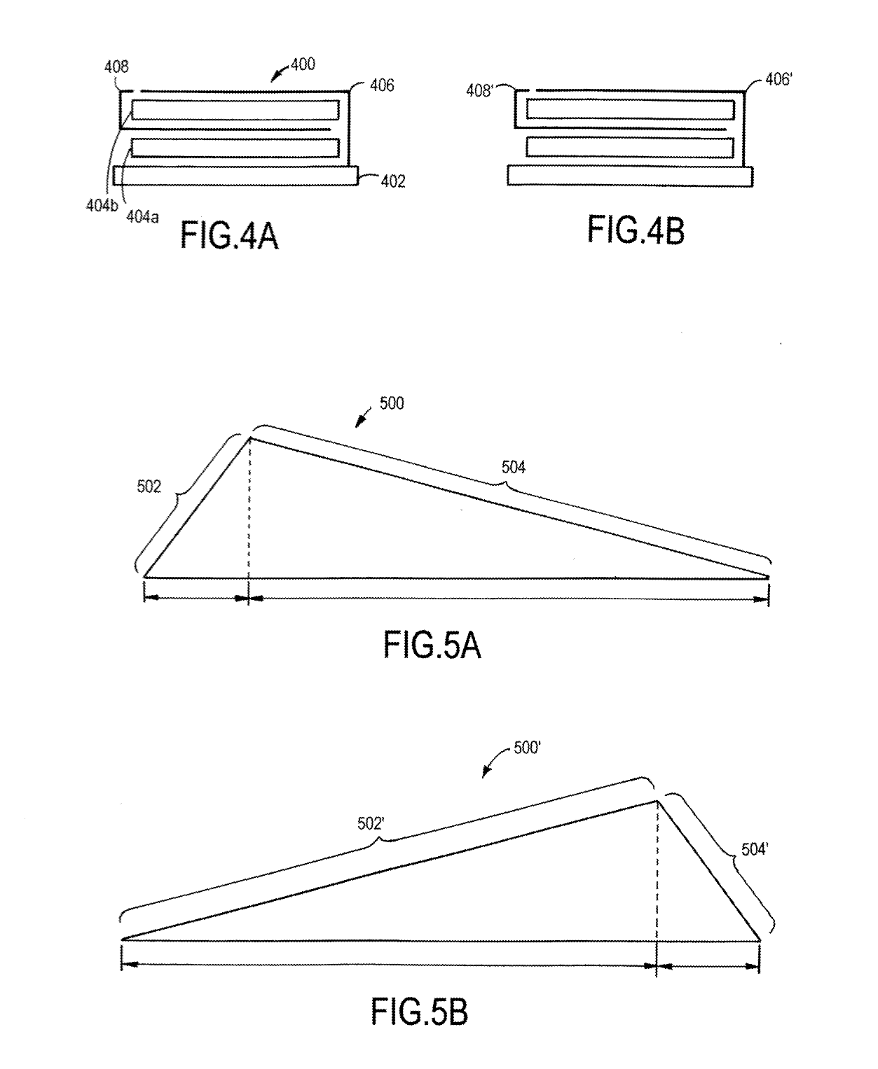

As mentioned above, it may be possible and/or desirable to employ capsense in conjunction with piezo-actuation. In such embodiments, it may be desired to shield the capsense from piezo driving signals. In a piezo structure, there may be a plurality of ways to provide piezo signals. For example, FIG. 4A is one possible embodiment of control lines for a piezo structure comprising piezos 404a and 404b. Metal carrying plate 402 (which may face the glass surface) may provide grounding and possibly serve as a shield. Control signal lines 406 and 408 as shown in FIG. 4A may not be optimally designed, however. As shown, line 406 is driven to 50V and may allow electrical interference with neighboring capsense lines. However, in FIG. 4B, if the polarities of lines 406 and 408 are reversed (as in lines 406′ and 408′), then line 406′ is at ground—and may prevent noise coupling to the capsense lines.

Piezo Driving Signals

In order to affect the feeling of a sharp button click for the piezo-actuators, it may be possible to create such a feeling from a high velocity deflection of the piezo structure. Embodiment for creating that feeling may be affected by using a fast ramp for the piezo driving signals.

FIGS. 5A and 5B are two possible embodiments of such a driving signal for a suitable piezo structure. In FIG. 5A, it may be seen that there are two ramps for charging/energizing the piezo structure—a first high-velocity (e.g., fast) charging ramp 502 (up to a first charging level—e.g., substantially in the range of 30-75V), followed by a slower decaying and/or discharging (e.g. slow) ramp 504. With this type of driving signal to the piezo structure, a click sensation occurs during the high-velocity portion 502 of the waveform. During slower decaying portion 504, the finger may tend to feel nothing or have a much less sensation.

Alternatively, in FIG. 5B, it is possible to have a slower charging/energizing ramp 502′ (up to a first charging level—e.g., substantially in the range of 30-75V), followed by a high-velocity decaying ramp 504′. As before, the click sensation tends to occur during the high-velocity portion of the waveform, 504′, at the end. The finger tends to feel nothing (or have a much less sensation) during the charging ramp.

Although both drive signals are possible for the present systems, the drive signal of FIG. 5B may be desirable from the standpoint of limiting the size of the current pulses. For some designs, the limit may be in the range of 100-200 mA. It may be desirable to reach the first charging level over a longer time period (e.g. longer than 1-2 ms ramp) to stay within such current limits. Thus, while it may be possible to reduce the current draw spikes with large storage caps, it may be desirable to avoid the added expense and board area requirements.

In other embodiments, it may be possible to design a PWM to drive the charge cycle, and a separate PWM to drive the discharge cycle. Due to the practical limitations of the driving circuit, or the desire to create other sensations (such as those that would be effective for proximity sensing), it may be desirable to construct driving signals using asymmetrical triangles (or other asymmetrical wave forms) as the basis functions. Varying heights, varying charge and discharge times, as well as varying the pulse-width schedule of the PWM driving the switcher, are all possible variations to affect different sensations.

In one embodiment, during a click event, the piezo may first be charged by generating a PWM that drives a simple FET/inductor/diode boost circuit. The PWM “on” time may be matched to the characteristics of the discrete components—e.g., it may be the time desired to establish max current in the inductor. Leaving the FET turned on any longer may tend to waste power by shunting current to GND longer than suitable. The overall charge time may be controlled by varying the PWM period. The charge time may be controlled to limit the maximum current spikes taken from e.g., the system's battery.

In one embodiment, the charge cycle may be run open-loop—i.e., the PWM may be run for a fixed number of cycles (possibly determined heuristically or by experimentation) to charge the piezo to the desired voltage. However, the relationship between the final piezo voltage and the number of PWM cycles may depend on many variables in the system, including the actual piezo capacitance, the driver source voltage, the FET, diode, and inductor characteristics, etc.

Once the piezo has been charged to 60V, it may be quickly discharged back to the driver idle voltage (e.g., ˜5V). This discharge may be performed by generating another PWM that drives a discharge FET/resistor. The resistor may provide a limit on the discharge rate (e.g., ˜600 uS)—so for a maximum discharge rate, the PWM may not be desired and may just be run wide open (100% duty cycle). Slower discharge rates may then be achieved by adjusting the PWM duty cycle.

As with charging, the discharge cycle may also be run open loop, i.e. it is possible to discharge the piezo for a fixed number of cycles. However, it may be desirable to have a suitable number of cycles. Otherwise, there may be some residual voltage on the piezo, which could build up over repeated actuations and may interfere with accurate pressure sensing.

In one embodiment, it may be desirable to close the loop on the charge and/or discharge cycles. It may be desirable to have an additional circuit that can measure the voltage across the piezo. Due to the high voltages used to drive the piezo and the low voltage produced by the piezo when used as a sensor, it may be desirable to have multiple gain modes in the measurement circuit. Switching between the gain modes may be done to ensure voltage limits are not exceeded on sensitive components such as FET amplifier and/or ADC inputs. For example, during discharge it may be desirable to switch the measurement circuit from low gain mode to high gain mode. However, it may be undesirable to do this too early—as the high voltage may damage components in the measurement circuit. Therefore, it may be desirable to discharge first in low gain mode until a piezo voltage is reached that, when switched over to high gain mode, may still be within the operating range of the measurement circuit. It may then be possible to continue to discharge in high gain mode until the desired driver idle voltage is reached.

Depending on the characteristics of the FET, it may be possible that the lowest measureable voltage in low gain mode may still be higher than the highest measureable voltage in high gain mode. In this case, it may be desirable to run the discharge open-loop for several additional PWM cycles before switching to high gain mode.

However, one concern with closing the loop on the piezo discharge may be that the time constant of the measurement circuit may not be insignificant compared to the total piezo discharge time. Therefore, by the time the system senses that the piezo voltage is as desired, it may have already been discharged beyond that point.

Thus, it may be desirable to anticipate this and terminate the discharge cycle when the sensed voltage is somewhat above a desired target. For example, this voltage offset may be designed so there may be a slight residual voltage on the piezo left over. This would tend to avoid wasting power by turning on the driver diode during discharge. This offset may not accumulate over repeated actuations because the system may discharge to the substantially same voltage after each actuation. The residual voltage may slowly discharge to the driver idle voltage (e.g., via leakage in the measurement circuit and piezo). In one embodiment, the pressure sensing algorithm may be designed to allow the baseline to track downward as the piezo voltage drifts down.

In another embodiment, closed-loop discharge may be affected a long settling time of the mechanical system after a discharge. Thus, even after the system has stopped discharging, the piezo voltage may continue to change while the mechanical system (piezo, adhesive, glass, finger, etc.) settles to its final steady state condition. In one embodiment, the time constant of this mechanical system (30-50 ms) may be long compared to the total discharge time (<1 ms). Typically the piezo voltage may increase after discharge is stopped. If the system attempted to resume sensing piezo pressure soon after the end of the discharge cycle, the system may see the piezo voltage rising fast enough and far enough to indicate increasing finger pressure on the piezo.

Thus, it may be desirable that, after each haptics event (charge followed by discharge), the controller may enter a special haptics recovery mode. In this mode, pressure sensing may be suspended and the piezo voltage is discharged approximately every 10 ms until a specified settling time (35 ms) has expired. At the end of this settling time, it may be the case that the mechanical system is sufficiently settled and pressure sensing is resumed.

Piezo Pressure Sensing Embodiments

When using the piezo as a sensor, it may be possible to measure the voltage across the piezo—e.g., when it is not being driven as an actuator. If the piezo is not being deflected by any pressure from the user's finger, this voltage may tend to be the idle voltage generated by the piezo driver. This idle voltage may vary slowly due to component variations, temperature, etc. However, it may be possible to calibrate out these slow variations to detect faster variation due to piezo deflection caused by pressure from the user's finger. It may be possible to compare the current piezo voltage to the calibrated baseline voltage and “detect” a press when the difference exceeds a threshold. Therefore, to activate the virtual button, the user would press down slightly on the virtual button sensor.

This embodiment may be sensitive enough that only a light pressure on the virtual button is applied for detection. In one embodiment, the piezo driver may be activated to give the user haptics feedback—e.g., that the button has been pressed. This haptics feedback may consist of a gradual (approx. 10 ms) ramp up of the piezo voltage (e.g., to ˜60V) from its starting point (e.g., of ˜5V) plus the pressure-induced voltage. Once the piezo voltage reaches a desired level (e.g., 60V), it may be quickly discharged (e.g., in about 1-2 ms). It is this rapid discharge that creates the “click” feel (and sound) of a dome switch being depressed.

Once the discharge is done, it may be possible to resume using the piezo as a pressure sensor to determine when declining pressure from the user's finger indicates a “release” of the virtual button. In one embodiment, it may be desirable to use piezo pressure to detect button press—while using the capacitive sensors to detect release. This embodiment may provide feedback to the user that tends to be consistent with a mechanical dome switch. In this embodiment, it may be desirable to detect the release and trigger the haptics feedback before the user's finger has actually left the surface, otherwise the click will be heard but not felt. Therefore, the capacitance of the user's finger may be measured prior to initiating the press haptics feedback. After the press click event is done and the mechanical system has been allowed to settle, it may be possible to resume capacitance measurements. The system may keep track of the peak capacitance measurement measured (e.g., starting with the measurement taken just prior to the press haptics event) and detect button release when the finger capacitance falls to ⅞ths of the peak (e.g., relative to the baseline, no-touch capacitance). This may allow the system to have a sensitive release threshold while still compensating for wide variations in touch capacitance. In addition, using a lower threshold (e.g., ½ of the peak) may tend to reduce the probability of noise-induced, early release detection.

In one embodiment, the system may use capacitive guard sensors. When any of these guard sensors are being touched, the virtual button may be deactivated. This may tend to prevent a user—who is applying broad pressure in the virtual button area (while carrying or gripping the product)—from activating the virtual button. Therefore, only when the system sees one of the capacitive virtual button sensors being touching without any of the guards being touched does the system “prime” the piezo pressure sensor and begin looking for a press event. The sensor may stay “primed” as long as one of the virtual button sensors is touched without any guards being touched. The touch panel area near the virtual button sensor may be treated as a third “guard”. Any touches in this area may tend to have the same effect as touching the guard sensors which may surround the virtual button sensors.

Piezo Pressure Baseline Measurement

In one embodiment, the piezo pressure baseline may be the minimum pressure measured while the pressure sensor is “primed”. This may tend to ensure that if the user slides his/her finger onto the virtual button with a slight pressure, this will not be enough to activate the virtual button. The user would intentionally press down slightly on the virtual button with additional pressure before a button press will be recognized.

Proximity Detection

In some embodiments, there may be no surface features on the glass to indicate the position of the virtual button. In those embodiments, it may not be possible to locate the virtual button by feel alone. Therefore, to aid users in locating the virtual button by feel, a proximity detection haptics feedback may be implemented. When the user swipes into the virtual button thru one of the guards, a special piezo “rumble” may be activated as soon as the virtual button sensors are touched without any guard sensors. The rumble may comprise of a sequence of haptics clicks that have lower amplitude (<60V) and slower discharge edges than a normal click event. There may be one click per sample period, or approximately 100 clicks per second. The amplitude of the clicks may increase as the total virtual button sensor capacitance increases so the user feels a slight increase in amplitude as his/her finger becomes more solidly centered on the virtual button sensor. The rumble may stop after a fixed number of clicks or as soon as any guard touch is detected or the virtual button touch is removed. The number of clicks may be selected (e.g. 15 clicks or approximately 150 ms) as desired to provide useable proximity detection.

In addition, in some embodiments, it may be possible—when the virtual button sensors are touched directly without swiping thru one of the guards—to have the proximity detect rumble suppressed. If this is not done, when the user is performing a direct intentional press of the virtual button, the user may feel the proximity rumble prior to the press click which may tend to degrade the dome switch feedback.

If multiple guards are detected simultaneously, the proximity detect rumble (and priming of virtual button detection) may be suppressed until all touches are removed. This may tend to prevent the user from feeling any rumble when the user is gripping or carrying the device in the virtual button area.

Tap Detection

Even though the virtual button can be activated with a very light press, it may still be desirable to detect virtual button activations for very short taps which do not provide enough pressure to exceed the pressure threshold. In one embodiment, when one of the virtual sensors is touched without swiping thru any of the guards, the virtual button signal may be asserted; but no haptics feedback may be generated. If the touch is removed a short time later without the pressure sensor detecting a virtual button press above the pressure threshold (and if this removal is not followed within a few samples by a guard touch), then the touch may be considered to be a valid tap. The virtual button signal may be de-asserted, a single haptics click may be generated, and the system may interpret the tap as valid.

If the duration of the tap is too long (˜400 ms), tap detection may be suppressed, no haptics click is generated, and the tap may be reported as invalid. This may be affected to deal with the case where the user rests his/her finger on the virtual button intending to press it but later changes his/her mind and removes his/her finger.

If a pressure-induced press is detected before the touch is removed, tap detection may be suppressed for the remainder of this touch and virtual button presses may be detected and reported as normal.

Piezo Driving Circuit Embodiments

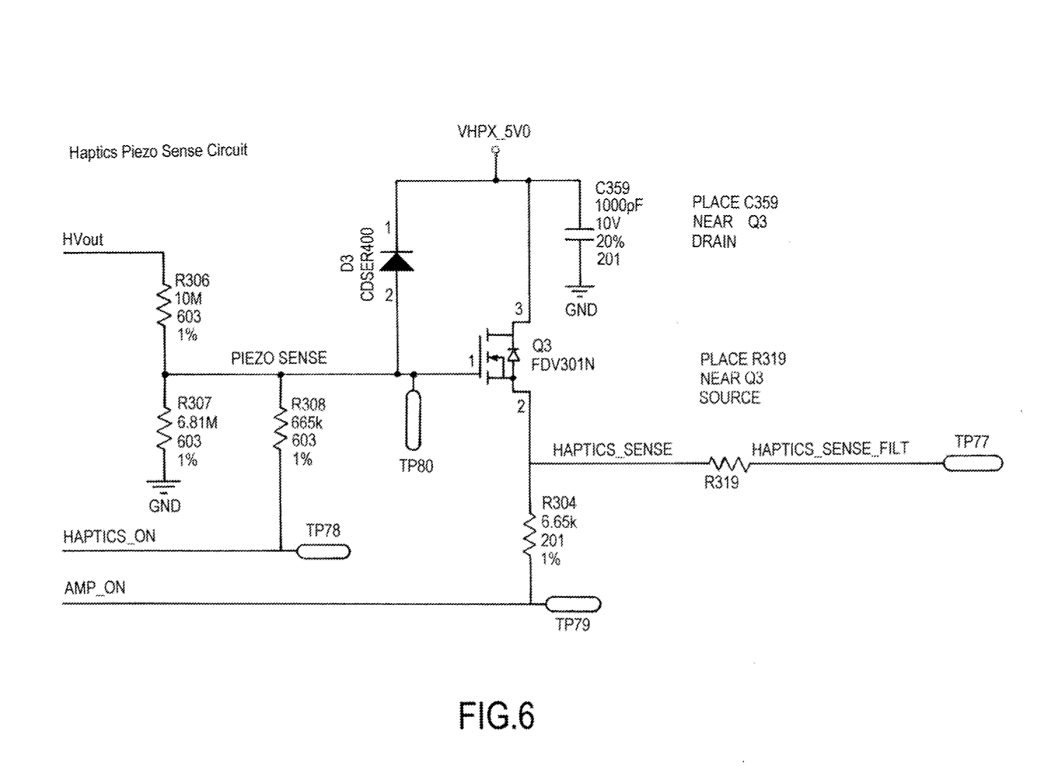

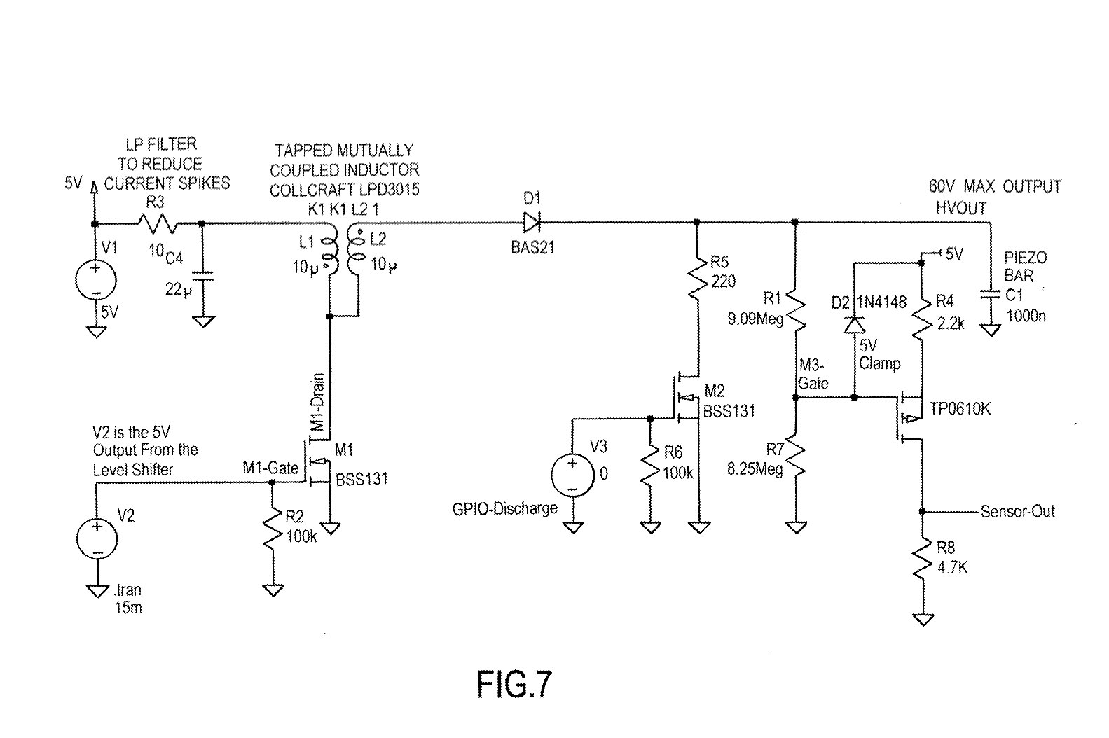

FIG. 6 is one embodiment of a piezo sense circuit and FIG. 7 is one embodiment of a piezo driving circuit for a suitable piezo structure. As may be seen, V1 is a voltage source (e.g., a battery voltage). C4 stores charge, thus limiting the size of current spikes. Inductors L1/L2, diode D1, and FET M1 form the switching components. V2 represents a PWM output from the piezo controller for the charge cycle, possibly after going through a level shifter to bump the voltage up to a desired level (e.g., 5V) to turn the FET on harder. V3 represents a PWM output from the piezo controller for the discharge cycle. FET M2 performs the discharge. R1, R7, D2, PFET M3, R8 and R4 form the piezo sense circuit. Sensor-out connects to an ADC channel on the piezo controller. The P-FET M3 is turned on at low piezo voltages, and gets pinched-off at high voltages, so the output is inverted: as pressure is increased the voltage drops. It may be desirable to add a filter capacitor in series with R4, right at the ADC input. D2 conducts to protect M3 when the piezo is activated to high voltages.

FIG. 8 is one embodiment of a piezo controller in communication with a piezo drive circuit and piezo element. As noted, piezo element 804 is in communication with piezo drive circuit 802. Drive circuit 802 is in further communications with piezo controller 806. Piezo controller 806 may supply drive and/or control signals (808) to piezo circuit 802—e.g., piezo charge PWM signal, piezo discharge PWM signal, enable and gain select line for sense circuit, enable line for level shifter (if needed). In addition, piezo drive circuit may send back the piezo voltage for ADC signal, as desired. In addition, piezo controller 806 may control the capsense system (if integrated with the piezo structures) of a virtual button.

Inadvertent Activation Defense

Introduction and Overview

As mentioned previously, actuating “virtual buttons” (i.e., areas on touch sensitive screens that—upon a user's touch—means to affect some function, like e.g., hitting a real button) on a touch screen surface may tend to have certain challenges. For example, virtual buttons may tend to feel different from authentic mechanical buttons that have an “up” and “down” feel to their actuation. Virtual buttons may also have a high number of “false” readings—i.e., they may poorly indicate to the system (which detecting touches and interpreting their meaning) that the user has intended to push a virtual button on the screen.

Thus, it may be desirable to implement and/or affect systems and methods on touch-enabled smart devices that guard against “inadvertent actuation” of virtual buttons. Such inadvertent actuation defenses (“IA defenses”) may refer to tactics employed to prevent actuations unintended by a user. In one embodiment, when a user interacts with a touch button, the system should determine the user's intentions, using sensor features and algorithms. In another embodiment, the IA defenses should also distinguish and recognize actions that should not result in actuations. For example, if the system can distinguish between a palm press and a finger press, and it is desired to activate a touch button only by a finger press, it is desirable that the IA defenses reduce or eliminate actuations caused by palm presses.

It may be desirable to detect the intent of a person's hand(s)/finger(s)—e.g., while ensuring that intentional button presses are recognized and unintentional button presses are ignored. In many embodiment, it is also desirable to disambiguate grip postures where parts of a hand are covering the button from discreet finger presses; disambiguate off target finger presses from on target finger presses; disambiguate gesturing fingers sliding across areas near or directly over the button from stationary fingers; disambiguate touching from something else touching. All of these aspects may tend to increase the fidelity of a virtual button experience and the confidence with which users will have when interacting with one.

For detecting the intent of a person's touches, it is possible for one embodiment to use a proximity sensor(s) like capsense or other touch screen technologies, pen/pencil sensors/digitizers, or a pressure sensitive sensor such as an FSR, or piezo pressure sensing (e.g., by sensing the voltage created directly by bending a piezo). In addition, firmware deciphering the sensor signals and a software button driver may be used in combination to combine, evaluate, and determine valid and invalid button presses, report valid button presses to the Operating System (OS) in combination with other hardware buttons/input.

In the area of IA defenses, there are many embodiments that utilize hardware configuration and/or firmware/software configurations—and any combination of both hardware and firmware/software techniques to affect a desired level of IA defense capability.

On the hardware configuration side, one embodiment is to use the pressure sensing techniques described above using a piezo element under the touch surface, thus enhancing IA defenses and creating a more mechanical-button-like experience.

In other hardware configuration embodiments, it is possible (and perhaps desirable) to use additional touch areas in and around an area identifiable to the user as a virtual button area, as will be described further herein. Such embodiments may use touch data from neighboring touch systems, where such touch systems may be of any type known in the art (e.g., piezo, capacitive, resistive or the like). Such embodiments employ the use of these adjacent “guard” sensing areas, regions and/or sensors, and the use of other proximal touch data (e.g. touch data from a nearby multi-touch touchscreen), to recognize and block inadvertent actuations.

In firmware/software configurations, it may be possible to employ other user activations—in conjunction with user touches in a virtual button area—to aid in IA defense. In one embodiment, in the context of a smart phone, tablet, laptop or the like, the smart device may consider a user pressing another button (e.g. real or virtual) to help discern an intentional touch of a virtual button. For example, the smart device may recognize additional states if—while the user activates the virtual button—the user actuates other (e.g., physical) switches and/or buttons on the device (e.g., keystroke, mouse inputs, ON button, volume UP/DOWN, etc.). There may also be different interpretations, possibly depending upon whether the user “holds” a button for a period of time, or holds then releases.

In other embodiments, a present system may employ any combination of hardware configurations and firmware/software configurations to improve the IA defense capability of the system. For merely exemplary reason (and not meant to limit the scope of the present application), the following may be considered by system builders in any combination:
(1) Using one or more capacitive sensors and/or areas to sense finger pressure, position, motion and hand position for determining intentional button actuation and/or preventing unintentional button actuation;
(2) Using a Touch Display in concert with another sensor array to determine intentional button actuation and/or preventing unintentional button actuation;
(3) Using orientation sensors to inform virtual button of when button presses may be valid and when they may be invalid; and/or
(4) Using a digital Pen or Pencil sensor to disable and prevent actuation while the Digital Pen or Pencil is in use.

One Embodiment Employing Neighboring Guard Sensors

To help the system to discern between a valid from an invalid contact with the virtual button, it may be desirable to employ guard sensors that are neighboring to the areas considered as the “virtual button”.

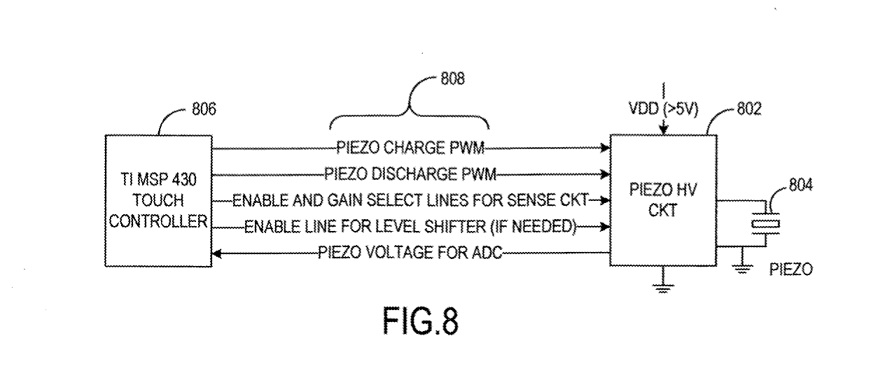

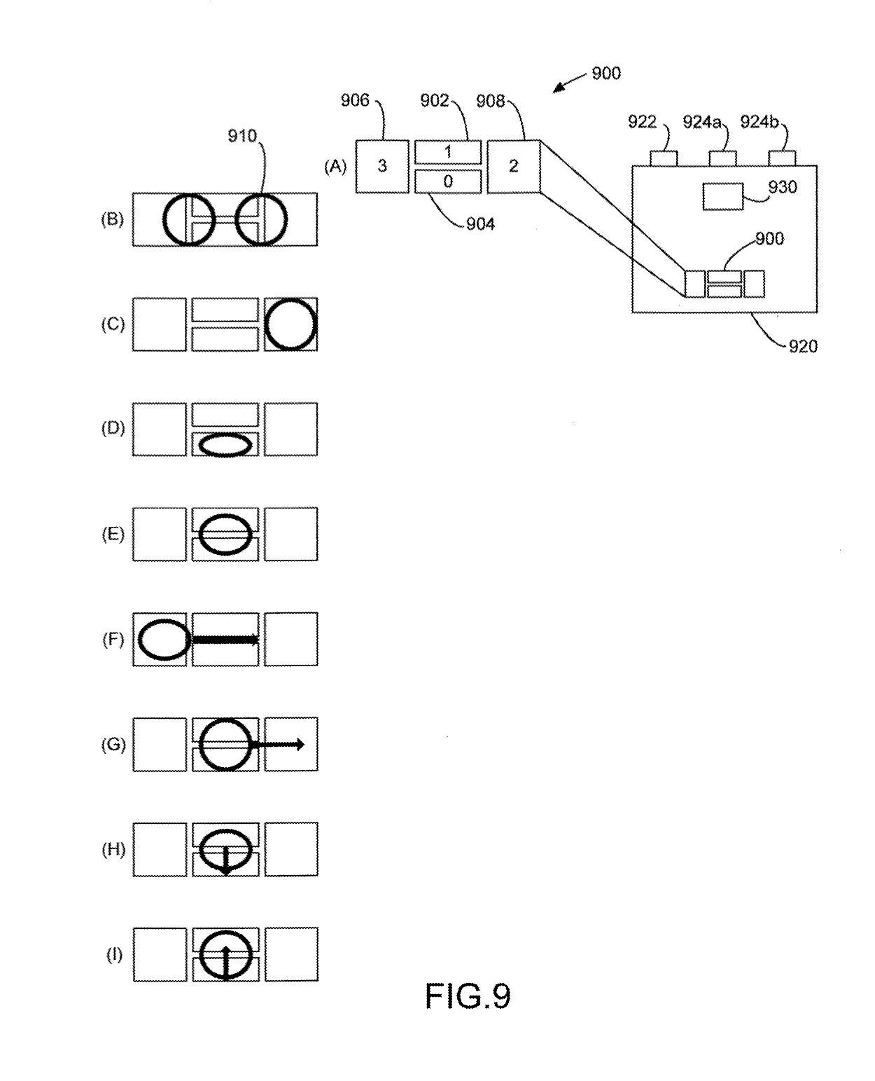

FIG. 9A gives one embodiment of such a system. Touch screen 920 (e.g., as used in a smart phone, tablet, laptop or the like) may have within its borders an area 900 that may be understood by users as a “virtual button”—and that touching in at least the center of that area, will be understood as actuating some function within the smart device that is associated with that virtual button.

Touch screen 920 may also be a smart device/mobile device platform. As such, there may be other, possibly physical buttons that may be actuated on the device. For example, there may be a Power button 922, a Volume Up (+) button 924a, a Volume Down (−) button 924b. Each of these buttons may be associated with a primary function and/or process—e.g., Power button turns on/off the device, Volume Up/Down turns up or down the volume of sound systems, etc. As will be discussed further herein, these buttons may have a secondary (tertiary, etc.) function/process associated with them upon user activation, when made in the context of a valid (or at least construed valid) virtual button actuation/activation/touch that may be substantially at the same time (or other conditions satisfied) as the button actuation/activation.

Controller 930 may also be a part of such a smart/mobile device that may be in communication with the virtual buttons/actual buttons/touch screen (e.g., either directly or via other controllers, such a touch controller). Controller 930 may also execute Operating System (OS) functions (and other application functions) for a smart device/mobile device, depending upon the functionality of the device—e.g., a smart phone, tablet, laptop etc. It may suffice that controller 930 have sufficient processes and/or storage to affect the execution of processes that may be associated with the virtual buttons, touch screen sensors/areas and/or physical buttons, etc.

Virtual button area 900 (as seen expanded) may further comprise several regions. In one embodiment, there may be a center region (902, 904) that is understood by the user as the virtual button. In addition, there may be surrounding and/or neighboring regions (906, 908) that comprise guard sensors that are touch sensitive themselves; but may not be understood by the user as being a part of the virtual button.

The touch sensitive regions (902, 904, 906 and 908) may comprise any known touch sensitive technology—e.g., piezo, capacitive, resistive or the like. In some embodiments, the center regions may comprise the piezo structures mentioned herein—in order to provide a noticeable tactile/haptic feedback to the user upon pressing the virtual button's center region.

In addition to the hardware configuration of neighboring guard sensors on the touch screen surface, it is also possible to apply a firmware process to discern traits of certain touches made be the user—e.g., to interpret the meaning of touches and gestures. In general, invalid contacts may be any contacts that do not meet the requirement of being in contact with either center sensors.

FIGS. 9B through 9I are merely exemplary touches that—when detected by the system, may be given a particular meaning by the system. As seen, touches are indicated by the dark circle 1010 and any movement of the touch is indicated by arrows. FIGS. 9B to 9E are examples of static touches (i.e., with no movement detected and possibly held for a threshold period of time).

FIGS. 9B and 9C may be examples of when touch is detected on either or both of the guard sensors (or partially in the center region; but mainly in the guard sensor region). Alternatively, the touch may cover the entire area 1000. In these cases, actuation of the virtual button may be suppressed—as it may be interpreted as an inadvertent touch of the virtual button. This interpretation may help guard against several scenarios:
(1) Actuation while the user is gripping the edge of the tablet;
(2) Holding it in portrait mode with a hand;
(3) Carrying it like a notebook in a hand;
(4) Actuation while the user is edging;
(5) Swipe in from the bottom to activate the application menu for the current app (e.g., to affect an OS function);
(6) Actuation while panning/scrolling the UI; and/or
(7) Left/Right movements of the finger and/or hand.

FIGS. 9D and 9E may be interpreted as a valid/intentional activation of the virtual button.

For touches that employ a movement aspect, there may be several interpretations associated with initial touches and movements. For merely some examples, FIGS. 9F through 9I offer some possible embodiments. FIGS. 9F and 9G may be interpreted as conditions for an invalid contacts—as swipes across the center region may be interpreted as inadvertent. FIGS. 9H and 9I (which may be a swipe across the center regions to or from e.g., the bezel of the touch screen) may be construed as either valid or invalid, depending possibly on the satisfaction of other conditions.

It will be appreciated that there are many other different touches (either with or without associated movement) that may have different interpretations as valid/invalid conditions by the system. In addition, it should be appreciated that these touches in FIGS. 9B to 9I may be given different interpretations by other systems—or even by the same system in a different context (e.g., other button activations at the same time or different system and/or OS states in effect at the time of the touch). It may suffice for the purposes of the present application that the system has some firmware/software that may imbue certain touches and movements as valid and/or invalid conditions for aid in interpreting meaning from a user's touch and interaction. These touches and/or movements may combine with other conditions as noted herein to aid in distinguishing intentional from inadvertent (e.g., valid from invalid) VB actuations—e.g., actuation of other buttons, length of time of VB button touches, movement, amount of pressure within VB button areas, touches and movement within guarding sensing areas and the like.

One Firmware Embodiment

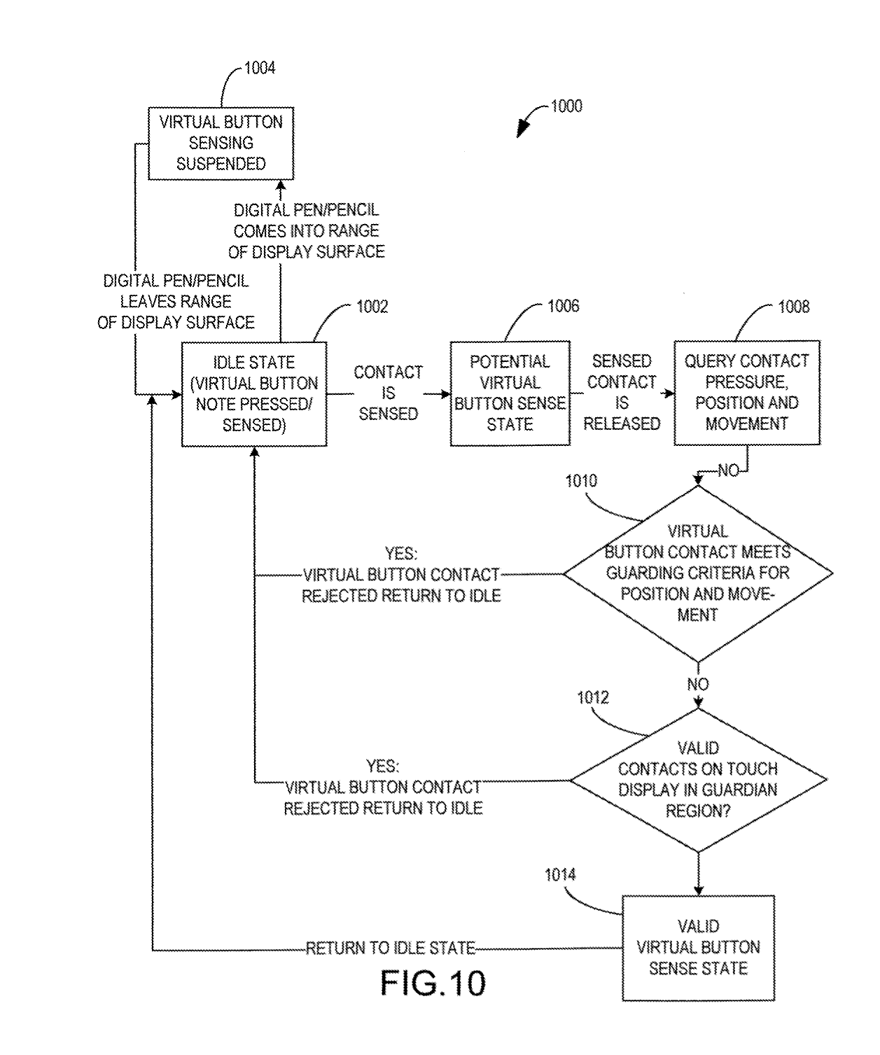

FIG. 10 is one embodiment of a process (1000) to interpret intentional/valid touches and/or contacts with a virtual button (e.g., center sensor) press from inadvertent/invalid one. This process may be implemented in firmware and/or software and may reside with the host CPU or other controller in a smart device.

At 1002, the system and/or device is in an idle state and remains until either a digital pencil is detected in within the region of the touch screen's surface. If that happens, then the system may choose to suspend virtual button sensing at 1004 and re-enable it if the pen/pencil is no longer so detected. Otherwise, the system may move to a potential VB sense state 1006 that indicates a contact has been made with the VB (and/or center sensors, if neighboring guard sensors are employed). The system may note the amount of time that the contact is held and other conditions. If the contact is sensed as released then the system may at 1008 query for the conditions sensed—e.g., amount of contact pressure, position of the contact (e.g., in or around guard sensors) and any movement associated with the contact. If the system detects contact that meets guarding criteria for position and/or movement at 1010 that interprets an invalid VB push, then the VB push may be rejected as inadvertent and the system may return to an idle state (1002).

Otherwise, the system may query at 1012 that for contacts that might be construed as valid contacts, have any contacts occurred with the guard sensor region of the VB. If there were contacts in the guard sensor region which meet certain criteria for a contact that should be rejected, then the system may transition to an idle state 1002. Otherwise, a valid and intentional VB push may be affected at 1014 and the appropriate firmware/software commands associated with such valid VB push may occur. The system may transition back to an idle state thereafter.

Grip/Swipe Suppression

Additional alternative embodiments involving a grip and/or a swipe are also possible. For example, in one embodiment, a virtual button press should only be indicated by the firmware for an obvious intentional press of the virtual button. The firmware should reject false virtual button presses that might be caused by the user gripping the device in the virtual button area or swiping across the virtual button area while using the touch panel.

Primary Grip/Swipe Suppression

When a touch is detected on guard sensors, the virtual button may be suppressed until all sensors are detected as untouched for N consecutive samples. This suppresses false virtual button presses due to gripping the device in the virtual button area or when swiping across the virtual button area horizontally. The value of N can be a configurable paramater.

When a touch is detected on either of the virtual button sensors (0 or 1) for N consecutive samples (and the virtual button is not currently being suppressed) then the virtual button may be considered to have been pressed and the virtual button signal to the host is asserted. The value of N can be a configurable parameter. Forcing the virtual button to be touched for some minimum number of samples suppresses false virtual button presses that might occur due to a grip that briefly touches the virtual buttons before touching the guards. It may also suppress fast swipes that originate at the virtual button and move quickly out to the guards.

Increasing the sample setting may improve grip/swipe suppression but tends to add latency to the recognition of the down event (e.g., virtual button touch). If this latency is too long, it may tend to make the device feel sluggish when responding to virtual button presses. One solution that has been proposed to address this tradeoff is to respond quickly and/or substantially immediately to the down event by giving the user some feedback that his/her virtual button press has been recognized. This feedback could be a haptics pulse, an audible click, an LED turning on, etc. However, the actual down event may not directly result in any down event indication to the host. This may be delayed until the firmware can confirm that the down event is not part of a grip or swipe.

“Outward” Swipe Suppression

In one embodiment, it may be possible to interpret as invalid by the firmware the case where the user is touching down on the virtual button area, pausing there for some indeterminate amount of time (which could be arbitrarily long) and then swiping over one of the guards before lifting his/her finger. This is referred to as an “outward” swipe since it begins at the virtual button and swipes outward from the virtual button towards the guards.

An “inward” swipe would start on or outside the guards and swipe in towards the virtual button. Inward swipes may be easily rejected by the primary grip/swipe suppression discussed above.

In one embodiment, it may be difficult to prevent the “down event” (i.e., touch initiation) user feedback (e.g., haptics, etc.) for outward swipes unless the system is willing to accept a very long and/or arbitrarily long latency. One way to “reject” an outward swipe may be to delay feedback to the host until the “up event” (i.e., touch removal), at which time the firmware may send both down event and up event indications to the host (since the host SW may see both). If a guard touch is detected before the virtual button touch is removed, the virtual button press may be suppressed and the host SW may see neither a down or up event. The user may receive immediate haptics feedback on the initial virtual button touch but nothing else will happen unless the user removes the touch in the virtual button area (possibly, without touching either guard during the touch).

In some hardware configurations, it may be the case that there is some spacing between the virtual button sensors and/or areas and the guard sensors and/or areas. In such configurations, it may be possible for a light, slow moving outward swipe to look like a valid virtual button press because the virtual button removal is seen before any guard touch is detected. These false indications may be minimized by minimizing the space between the virtual button sensors and the guard sensors. This may be done by making the virtual button sensors bigger rather than by moving the guard sensors closer to the virtual sensors. The later approach may result in valid virtual presses being rejected when a “fatter” touch (such as a large thumb) also touches the edge of one of the guard sensors.

False virtual button indications on outward swipes may also be minimized by adding a slight latency to the recognition of the touch removal. If no guard touches are seen in N samples after the touch removal then the virtual button press is considered valid and is sent to the host.

Vertical Swipe Suppression

In other hardware configurations/embodiments, it may be possible to include guard sensors above and below the virtual button sensors so that vertical swipes may also be rejected. However, in embodiments that may not have such additional guard sensors (due to space or cost considerations), it still may be possible to reject vertical swipes.

In one embodiment, vertical swipes may be rejected by using the device's main touch panel, and/or regions thereof, as a “guard”. In many embodiments, the firmware may monitor the touch panel's interrupt signal to the host. When the interrupt is asserted, it tends to indicate that the touch panel chip has new messages for the host. New messages tend to indicate new touches or changes in old touches. The firmware may treat every assertion edge of the interrupt as though it were a guard touch. Therefore, in this embodiment, some touch panel activity may tend to suppress virtual button presses. This is very effective at suppressing both inward and outward swipes between the virtual button and the touch panel. Inward and outward swipes between the virtual button and the outside edge of the device may not be rejected. In some embodiments, it may be that the assertion edge of the interrupt actually restarts an internal timer which then counts down until it expires. As long as this timer is not expired, it may be treated the same as a guard touch.

In some embodiments, it may be possible to isolate touch panel activity that is intentional and unintentional. For example, while a user may be holding the device in one hand touching the bezel and the touch panel and then tries to touch the VB, the touch may be considered valid and not suppressed. But, in another example, if a user is holding the device across the VB into the touch panel, this VB may be suppressed.

As with the horizontal swipe suppression, it may be possible to affect vertical swipe suppression when virtual button 1 (902) is very close to the edge of the touch panel. This may tend to ensure that slow vertical outward swipes do not result in removal of the virtual button press before touches are detected by the touch panel.

In yet another embodiment, it may be possible to affect vertical swipe suppression for instances of virtual button presses when the user is touching the touch panel in the region near the virtual button switch. This would allow shifting grips far away from the virtual button sensor to still pass thru virtual button presses. It may be possible to implement this by having the firmware snoop all host accesses to the touch panel chip, decode them, keep track of current touches and identify which touches are inside a region near the virtual button.

In yet another embodiment, it may be possible to have host SW/drivers decide when touch panel touches are near the virtual button and send a special command to the firmware to suppress virtual button presses for a specific period of time.

In yet another embodiment, it may be possible to have the touch panel controller detect touches in the guard area and assert a signal to the virtual button controller to suppress virtual button presses.

One Embodiment Employing Multiple Buttons Actuation

As mentioned previously, in some embodiments, it may be possible to associate VB pushes with other buttons—either physical or soft buttons—activation in order to determine intentional pushes.

In some embodiments, the purpose of the virtual button firmware and/or driver is to reject inadvertent touches on the virtual button and report only valid button events to the OS—as well as report other button combinations.

In such an embodiment, it may be the case that the resident GPIO buttons driver does not have an avenue to determine a genuine button press/release from an inadvertent virtual button press/release due its capacitive nature. The first interrupt received by such a driver may be considered as a button down event for the button associated with that interrupt, and a second interrupt may be a release event. In some systems, it may be the case that the button is held down before the GPIO driver started, then it may have missed the first interrupt and the button state will stay inverted from then on. In addition, there could be unintentional touches on the virtual button due to swiping the finger on the virtual button or even holding the device while griping over the virtual button area.

One VB Button Plus Other Button(s) Actuation Embodiment

The following is one embodiment of possible VB plus other button(s) actuations and/or interactions. In this embodiment, it may be desirable that the combination interactions with the VB Button may be commenced with the VB Button pressed and held, and then an alternative button (volume/power) button may be pressed. The event that occurs happens on button down for the alternative hardware button—e.g., VB Button+Power may send a ctrl+alt+del to the system on power button down.

In one embodiment, it may be desirable to take action on button down (rather than up) and to prevent the user from having the same result from any order of press or simultaneously pressing. To implement in this fashion, it is possible that:
(1) allowing for any order actions may introduce latency to the root behavior for the buttons. For example, it may be that the system would have to wait some time before acting on a volume down button to make sure the user was not also going to press the virtual button.
(2) The power button may be loaded with multiple functions already (e.g., put the system to sleep, shut the system down, and wake the system). To disambiguate between these actions, it may be desirable the action may be taken on button down so that the user may have substantially immediate feedback that an action is taking place. It may be desirable to apply this behavior to other buttons (e.g., the Volume+/−) as well for consistency.

In some embodiments, virtual button combination events may take place on the 2nd button down event. For example, VB Button+Volume Down may take a screen shot. The screen shot event may be sent to the system on volume button down, and the subsequent VB Button Up may be ignored (i.e. SAM may not send a VB Button down/up combination after the combo button is pressed). Additionally, if the VB Button continues to be held, and the volume button down is pressed again, another screen shot may be taken.

In some embodiments, it may be desirable to:

(1) reject the unintentional touches on the virtual button with the help of firmware and report only valid button press/release events to OS

(2) prevent the buttons from starting in an inverted state by taking into account the initial state of the buttons before at the time the diver loaded;

(3) allow virtual button firmware updates during development by providing an interface to the applications.

In some embodiments, the virtual button driver may utilize interrupt and IO resources for the following buttons (1) Power, (2) Virtual, (3) Volume Up and (4) Volume Down. The following events may then be noted:

(1) Power button press/release event;

(2) Virtual button press/release event;

(3) Volume Up button press/release event;

(4) Volume Down button press/release event.

In addition, the following button combination activations may also be noted and appropriately correlated:

(1) Virtual Button+Power Button

(2) Virtual Button+Volume Up Button

(3) Virtual Button+Volume Down Button

A virtual button driver may manage multiple buttons—e.g., four buttons: Virtual Button (VB), Volume Up button, Volume Down button and Power button. It may register for the interrupts generated from button presses/releases and take appropriate action before sending it up for further processing as a button press/release event. The following is a set of exemplary embodiments (and not meant to limit the present application):
(1) On a virtual button press and release event, it confirms the validity of the button press with the virtual button firmware when button is released and sends both buttons down and a button up event to the GPIO Buttons driver. Virtual button driver records the button down interrupt; waits for the button up interrupt and then checks with the firmware to see if that was a valid press/release; on confirmation of validity, sends a virtual button press and release event to the GPIO buttons driver.
(2) Any other button press (down) is recognized in the ISR by the corresponding interrupt and a button down event is sent to the GPIO buttons driver immediately. Same applies when that button is released.
(3) In the case of any non-virtual button press while the virtual button is already held down, then a virtual button ‘down’ and the other button ‘down’ events are sent to the GPIO Button driver. When the buttons are released, buttons ‘up’ events are sent for both the buttons involved in the combination.

During initialization the driver determines the initial state of the button by reading the corresponding GPIO resource. The virtual button firmware recalibrates if it senses continues touch for certain period of time (˜12 sec) and this causes an interrupt. Resetting the hardware while holding the virtual button down or beginning a ‘press and hold’ anytime during boot affects the state machine. For example

(1) If the driver is already up by the time the user presses and holds the virtual button, the interrupt for the button down event will be handled by the driver. After a certain period, while the user is still holding the virtual button down, the firmware may recalibrate. The recalibration causes an interrupt. This is interpreted as a button UP by the driver; but the user is still holding the button down. However, when the user releases the button, there is no interrupt generated.

(2) If the user presses and holds the virtual button before the driver starts, the driver does not see an interrupt for the button down event. If the user continues to hold the button long enough until the firmware begins recalibration, the driver will see an interrupt for button release event while the user still holding the button. This is again caused by recalibration and there won't be another interrupt when the user actually releases the button.

(3) If the user presses and holds the virtual button before the driver starts and releases it before the firmware would recalibrate, then the driver would see only one interrupt at the falling edge. However, the driver would have adjusted the internal state machine based on the GPIO status during initialization and will handle the button release interrupt correctly

The Virtual Button firmware may be designed to send the down/up event on release, unless another button (e.g. power, volume +/−) is engaged as well.

### One Exemplary Embodiment

The following is one exemplary embodiment engaging VB activation with other button activation within the context of a user session. It will be appreciated that the following is meant to be merely illustrative and does not limit the scope of the present application.

Tablet is Awake

Tap

A single tap on the Virtual Button may take the user to the Start Menu or to the previous application, depending on the state of the UI at the moment of the tap. Comparison to the keyboard interaction is valid. A few scenario may be exemplary:

Scenario 1: The user is browsing the web, and wishes to check on the weather. They tap on the Virtual Button taking them to the Start menu. Their weather application has an active tile showing the current weather. They then tap the virtual button again, which takes them back to their browser session.

Scenario 2: If there are no applications running, this may result in no change in the UI. Thus, the user may be at the Start menu, and a tap on the Virtual Button may result in a button down and up event being sent, but there may be no resultant UI event.

Tap and Hold

There is no special functionality for tap and holding the contact in place for a period of time, unless a modifier key is pressed during the hold (see below for details). The tap and hold may not act unless released.

Tap and Hold+Power Button

This may result in a Ctrl+Alt+Del keys down is sent to the host. On release Ctrl+Alt+Del up may be sent to the host, taking the user from where ever they were in the OS to the “Lock Screen.” The event may be sent on power button down. The subsequent virtual button release may be ignored.

Tap and Hold+Volume Plus

On release, launches Narrator (Win+CTRL+F14). The event may be sent on volume button down. The subsequent virtual button release may be ignored.

Tap and Hold+Volume Minus

On Release, performs a screen capture (Win+F15). The event may be sent on volume button down. The subsequent virtual button release may be ignored.

Tablet is Connected Standby

Tap

A valid contact may assert the wake event. When the system is fully powered and in use, all invalid contacts may be defended against. While the system is in Connected Standby, the firmware and driver may be active and may be defend against all invalid contacts, except possible in a few scenarios:

(1) when contacts are traveling vertically (from the outside edge of system across the center virtual button sensors) towards the display, or visa-versa.

(2) when a contact is in contact with the guard region of the display and a valid contact is made with one or both center sensors.

If the system has been woken up, and a contact is in contact with the center sensors and in motion if the contact speed is slow enough (>150 ms), the touch sensor is awake by that time, and may be used as a guard sensor.

Tablet is Off

Tap

The Virtual Button has no impact on the tablet when the power is off.

Tablet is Booting

The Virtual Button has no impact on the table while the system is booting.

Tablet is in Rotation

It may be possible to implement suppression of virtual button events while the system is rotating by employing other sensor data—e.g., gyro sensor data.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

1. A touch screen system, comprising:
a touch screen;
a controller for receiving touch signals from said touch screen;
wherein said touch screen comprises at least one virtual button, said virtual button further comprising a first touch area and a second guarding area, said second guarding area disposed substantially near said first touch area; and
wherein further said controller capable of receiving touch signals from said first touch area and said second guarding area and said controller capable of actuating at least one process according to the satisfaction of a set of touch conditions.

2. The touch screen system of claim 1 wherein said touch signals comprises one of a group, said group comprising: a user touch upon said touch screen and a user movement upon said touch screen.

3. The touch screen system of claim 1 wherein said first touch area comprises one of a group, said group comprising: piezo pressure sensitive structure, capacitive sensitive structure, a resistive sensitive structure.

4. The touch screen system of claim 1 wherein said second guarding area comprises one of a group, said group comprising: piezo pressure sensitive structure, capacitive sensitive structure, a resistive sensitive structure.

5. The touch screen system of claim 1 wherein said first touch area comprises a piezo pressure sensitive structure and said second guarding area comprises one of a group, said group comprising: piezo pressure sensitive structure, capacitive sensitive structure, a resistive sensitive structure.

6. The touch screen system of claim 1 wherein said second guarding area neighbors said first touch area.

7. The touch screen system of claim 6 wherein said second guarding area substantially surrounds said first touch area.

8. The touch screen system of claim 1 wherein said touch conditions comprise a set of valid touch conditions such that the satisfaction of said set of valid touch conditions is associated with an intentional touch of said virtual button by a user.

9. The touch screen system of claim 8 wherein said controller capable of actuating at least one process when said set of valid touch conditions is satisfied.

10. The touch screen system of claim 9 wherein said set of conditions further comprises a set of inadvertent touch conditions such that the satisfaction of said set of inadvertent touch conditions is associated with an inadvertent touch of said touch screen.

11. The touch screen system of claim 10 wherein said controller capable of suspending the actuating said at least one process when said set of inadvertent touch conditions is satisfied.

12. The touch screen system of claim 1 wherein said touch screen system further comprises:
a set of primary buttons, each of said primary buttons associated with at least one primary button process when each of said primary buttons is actuated.

13. The touch screen system of claim 12 wherein said primary buttons further comprise one of a group, said group comprising: power button, volume up button and volume down button.

14. The touch screen of claim 12 wherein said controller capable of actuating a second button process when one of said primary button is actuated substantially at the same time as said virtual button.

15. A method of guarding a touch screen system from actuating a process associated with touch upon a virtual button upon said touch screen when such touch is inadvertent, the method comprising:
receiving a set of first touch signals from a first touch area, said first touch area within said virtual button;
receiving a set of second touch signals from a second guarding area, said second guarding area substantially near said first touch area;
testing conditions involving said first touch signals and said second touch signals;
actuating a process associated with a touch upon said virtual button depending upon the satisfaction of said conditions.

16. The method of claim 15 wherein said first touch signals are associated with a set of valid touch conditions.

17. The method of claim 16 wherein said second touch signals are associated with a set of inadvertent touch conditions.

18. The method of claim 16 wherein said method further comprises:
receiving button actuation signals from one of a set of primary buttons, said primary buttons associated with a first primary process when actuated; and
actuating a second process when said one of said primary buttons is actuated at substantially the same time as said virtual button.

19. A computer-readable storage media storing instructions that when executed by a computing device cause the computing device to perform operations comprising:
receiving a set of first touch signals from a first touch area, said first touch area within said virtual button;
receiving a set of second touch signals from a second guarding area, said second guarding area substantially near said first touch area;
testing conditions involving said first touch signals and said second touch signals;
actuating a process associated with a touch upon said virtual button depending upon the satisfaction of said conditions.

20. The computer-readable storage media of claim 19 wherein the instructions, when executed by the computing device, further cause the computing device to perform operations comprising:
receiving button actuation signals from one of a set of primary buttons, said primary buttons associated with a first primary process when actuated; and
actuating a second process when said one of said primary buttons is actuated at substantially the same time as said virtual button
